(19) United States
(12) Patent Application Publication
(10) Pub. No.: US 2006/0143053 A1
(43) Pub. Date: Jun. 29, 2006

(54) Insurance product

(76) Inventor: Frederick Roelof Van Rensburg, Gauteng (ZA)

Correspondence Address: LADAS & PARRY, 26 WEST 61ST STREET, NEW YORK, NY, 10023, US

(21) Appl. No.: 10/541,185

(22) PCT Filed: Jul. 26, 2002
(86) PCT No.: PCT/IB02/02923

§ 371 Date: Jun. 29, 2005

(30) Foreign Application Priority Data
Jul. 31, 2001 (ZA) 2001/6311

(51) Int. Cl. G06Q 40/00

(52) U.S. Cl. 705/4

(57) ABSTRACT

An insurance product, a method of insuring an article and an a method of compensating an insured person. The insured article is, in particular, a vehicle, motor bike or boat. An insurance product is provided comprising a policy whereby the insurer undertakes to compensate an insured person for a loss incurred as a result of the actual consideration obtainable by the insured person for an article being less than an agreed minimum consideration, when the insured person disposes of the article. The compensation is for the loss incurred as a result of the diminution in the value of an insured article due to the article having been damaged in an accident, notwithstanding that the article was competently repaired after the accident.

### TECHNICAL BACKGROUND

This invention relates to an insurance product, to a method of insuring an article and to a method of compensating an insured person. The article may, in particular, be a vehicle, motor bike or boat.

Existing insurance products for motor vehicles typically provide that should an insured vehicle be damaged in an accident and the cost of repairing the vehicle be less than the value of the vehicle, the insurer undertakes to repair the motor vehicle or to pay for the reasonable cost of repairs. However, when the insured subsequently disposes of the repaired vehicle, which would be many months or even years later, he often finds that he is unable to obtain the usual market price for that kind of vehicle because of the fact that the vehicle has been involved in an accident, notwithstanding that the vehicle was competently repaired after the accident. The insured has accordingly suffered a loss as a result of the accident for which he has not been indemnified. The invention aims to indemnify the insured against such loss.

### DESCRIPTION OF THE INVENTION

According to a first aspect of the invention there is provided an insurance product comprising a policy whereby the insurer undertakes to compensate an insured person for a loss incurred as a result of the actual consideration obtainable by the insured person for an article being less than an agreed minimum consideration, when the insured person disposes of the article.

The article may, in particular, be a motor vehicle.

The compensation may, in particular, be for a loss incurred as a result of the diminution in the value of the insured vehicle due to the vehicle having been damaged in an accident, notwithstanding that the vehicle was competently repaired after the accident. This is also known as “diminished value”.

The compensation may be a whole or partial indemnification of the loss.

The actual consideration may be a sum of money or may be a discount granted by a dealer in respect of the purchase price of another vehicle when the insured person trades in the insured vehicle.

The minimum consideration may be an average price for vehicles of the same kind as the insured vehicle having regard to, inter alia, the make, model, age, condition and extent of use of the insured vehicle.

The average price may be that determined by an independent party.

The insurance product may provide that until the average price becomes available, the liability of the insurer shall be limited to a percentage of the retail value of the insured vehicle when new.

The insured person may pay to the insurer a premium by way of a series of payments or a single payment.

The insurance may only be effective after a predetermined time period, and may endure for a further predetermined time period.

The area in which the insurance applies may be limited.

The insurance product may stipulate that the vehicle must be new at the time when the insured person acquired it.

The insured person may be obliged to maintain the article in a satisfactory manner.

The insurance product may stipulate that repairs are to be effected by authorised repairers.

The insured vehicle may need to be disposed of in an arm's length manner.

The insured person may be obliged to sell or trade in the insured vehicle to a predetermined person or class of persons.

The insured person may be obliged to obtain a specified number of quotations from different dealers for the values at which the dealers are prepared to purchase or exchange the insured vehicle.

According to a second aspect of the invention there is provided a method of insuring an article which includes undertaking to compensate an insured person for a loss incurred as a result of the actual consideration obtainable by the insured person for the insured article being less than an agreed minimum consideration, when the insured disposes of the insured article.

According to a third aspect of the invention there is provided a method of compensating an insured person, when the insured person disposes of an insured article, for a loss as a result of the actual consideration obtainable by the insured person for the insured article being less than an agreed minimum consideration.

The compensation of the second and third aspects of the invention may, in particular, be for a loss incurred as a result of the diminution in the value of the insured article due to the article having been damaged in an accident, notwithstanding that the article was competently repaired after the accident.

The minimum consideration of the second and third aspects of the invention may be an average price for articles of the same kind as the insured article, as determined by an independent third party.

### EXAMPLE

The invention will now be described, with reference to the following non-limiting illustrative example of an insurance product in accordance with the invention.

### Tradeshield Price Protection Policy

### Policy Preamble

This policy is the agreement for Trade-In Value Guaranteed insurance between Regent Insurance Company Limited (hereinafter referred to as “the Insurer”) and the Insured named in the proposal form/schedule that forms part of this policy.

Payment of benefits is conditional upon the payment and receipt of premium and acceptance of the proposal form by the Insurer for the period of insurance and in accordance with the definitions, procedures, exceptions, terms and conditions stipulated herein.

### Insuring Clause

The Insurer agrees to indemnify the Insured for the loss of value of a vehicle at the point of actual trade-in or re-sale of the insured vehicle due to the vehicle having been repaired as a result of accident damage, subject to the terms, exceptions and conditions set out below and subject to the maximum limit of R50 000.

### Basis of Settlement

The basis of settlement will be the difference between the highest available quotation in the market and the Trade-in Value as evidenced in the “publication” at the time of the actual trade-in or re-sale of the insured vehicle subject to additional considerations referred to under Administration and Claims below. If there is no trade-in value in the “publication” the Insurer will pay the amount by which the trade-in or resale price is reduced by reason of the accident, not exceeding 2% of the retail price of the vehicle.

### Premium

The premium payable to qualify for the benefits of the policy will be a precentage of the purchase price paid by the Insured for the vehicle stated in teh schedule, subject to a minimum premium, as determined from time to time by the Insurer. Premium is due within 15 days of the purchase date of the vehicle stated in the schedule and must be paid no later than 15 days thereafter for cover to commence from date of purchase.

### Duration of the Policy

“Tradeshield” Price Protection Policy will be in force for the duration of any finance or lease agreement applicable to the vehicle, subject to a maximum period of 60 months if the vehicle is not the subject of a finance agreement. Cover shall cease automatically with the termination of the finance or lease agreement or after 60 months if not financed.

### Publication

“The Publication” is the “Auto Dealers' Guide” published monthly by Mead & McGrouther for passenger vehicles and the “Commercial Vehicle Dealers' Guide” for Light Commercial Vehicles. Another similar publication used by all involved in the Motor Industry to determine trade-in or retail prices may be used by the Insurer if the said publication is no longer available for use.

### Insured Vehicle

All new passenger cars and new light commercial vehicles with a gross vehicle mass not exceeding 3 500 kilograms (kg) as stated in the vehicle's registration certificate, including double cabs, that are listed in the “Auto Dealer's Guide” or “Commercial Vehicle Dealer's Guide”. A new vehicle is one that has not been previously used or registered.

### General Conditions

Unless the following conditions are met, you will not be covered under this policy and will forfeit your right to claim:
1. Cover is limited to vehicles driven within the Republic of South Africa, Namibia, Swaziland, Lesotho and Botswana.
2. All cover granted under this policy shall be subject to the jurisdiction of the courts of the Republic of South Africa.
3. All reasonable steps must be taken by the Insured to guard the vehicle against damage.
4. The onus will be on the Insured to prove that any loss of value occurred due to accident damage.
5. Nothing contained herein shall give any rights against the Insurer to any person other than the Insured. Further, the Insurer shall not be bound by any passing of the Insured's interest in the vehicle other than by death.
6. Misrepresentation, non-disclosure or omission of any material fact by you or anyone acting on your behalf shall render the cover void.
7. If the insured vehicle is outside the Republic of South Africa, it must be repatriated at the expense of the Insured prior to consideration of the claim.
8. Should there be any other insurance covering such a loss, then the Insurer shall not be liable to pay or contribute more than their rateable proportion of such a loss.
9. If any claim be in any aspect fraudulent, or otherwise improper or improperly processed or submitted, or if any fraudulent or improper means or devices are used by the Insured or anyone acting on his/her behalf to obtain benefit under this policy, all benefits under this policy shall be forfeited.
10. The policy cannot be transferred to any other person or vehicle, nor is the premium refundable in any circumstances.
11. The policy only covers an insured vehicle that is a new vehicle at the time it is purchased.
12. The vehicle is to be serviced and properly maintained according to the manufacturer's specifications and in accordance with the requirements of this policy as set out in the Service and Maintenance Procedures.
13. Records of all accidents must be kept in accordance with the requirements of this policy as set out in the Accident Procedures.
14. In the event of accident damage to the vehicle, the Insured must comply with the Accident Procedures as set out below.
15. In the event of a claim, the Insured must comply with the claims procedures as set out in the Claims and Settlement Procedures.
16. The policy will be cancelled without any refund of the premium if the insured vehicle is not available for inspection by the Insurer or the Insurer's appointed representative or evaluator in the event of a claim. If there is any dispute, the vehicle must be evaluated by an independent evaluator.

### Service and Maintenance Procedures

1. The vehicle is to be serviced and maintained as per the manufacturer's recommended service intervals and according to the manufacturer's specifications.
2. Service and maintenance of the vehicle must only be carried out by a manufacturer's approved service agent and or selling dealer.
3. If such a dealer is not available then the vehicle must be serviced and maintained by a reputable dealer approved by the manufacturer.
4. Proof of service and maintenance must be kept in the original service manual of the vehicle. The manual must be kept up-to-date.
5. In case of a lost service manual, written proof must be obtained from the service agents.
6. The vehicle must be kept in a road worthy condition at all times.
7. The tyres must be replaced when they cease to be road worthy, or as per manufacturer's specifications, or every 65 000 kilometres, whichever occurs first, and proof of purchase must be kept.
   If there is failure to comply with the Service and Maintenance Procedures you will forfeit any right to claim under this policy.

### Accident Procedures

1. Records of all accidents and cost of repairs must be kept.
2. Photographs of all accident damage must be taken prior to the commencement of repairs and on completion of all repairs.
3. All repairs must be carried out by manufacturer's approved panel beaters or repair agents.
4. If such a panel beater or repair agent is not available, then the repairs must be carried out by a competent panel beater approved by the manufacturer or selling dealer.
5. The space provided for accident records in the policy document must be stamped and kept up-to-date at all times.
6. All the abovementioned documentation must be provided to the Insurer at the time of a claim.
   If there is a failure to comply with the Accident Procedures you will forfeit any right to claim under this policy.

### Claims and Settlement Procedures

Claims Notification

The Insured must, in the event of a prospective sale or trade-in, contact the Insurer as soon as possible if a claim might arise from the transaction.

In the event of loss or damage:

1. The Insured must obtain quotations for the value at which the vehicle will be sold or traded in from three different Franchise Dealers. These documents must be forwarded to the Insurer, together with other relevant documentation required prior to settlement being agreed.
2. The Insured must also forward to the Insurer, all documentation reasonably required by the Insurer including the documents referred to under Service and Maintenance Procedures, Accident Procedures, Claims and Settlement Procedures and Administration and Claims regarding the accident damage that caused the loss of value.
   Administration and Claims
   The Insurer will handle all policy administration and claims
1. The abovementioned quotations must be verified by the Insurer prior to the settlement of any claim.
2. In the event of a dispute, an independent evaluator will be appointed by the Insurer to evaluate the insured vehicle to determine the loss of value due to accident damage.
3. The Kilometres and Conditions Chart as set out in the Mead & McGrouther “Auto Dealers' Guide” and “Commercial Vehicle Dealers' Guide” will be applied in respect of valuations. The Chart will be used to determine the correct Trade-In Value according to kilometres travelled and general condition of the vehicle.
   If there is failure to comply with the Claims and Settlement Procedures you will forfeit any right to claim under this policy.

### General Exceptions

The Insurer will not be liable in respect of:

1. Any vehicle used for the following purposes:
   Racing, speed testing, or any use of a competitive nature.
   Outside the manufacturer's design intention.
   Hiring or self-drive hire.
   Driving instruction for reward.
   On the airside of airports or airfields.
   Security companies or armed response vehicles.
   Courier service or express delivery vehicles.
   Armed forces or police vehicles.
   Towing companies.
   Vehicles not registered in the Republic of South Africa.
2. Accidental damage caused by manufacturer's design or production defects.
3. Vehicles where accident repairs or services have been effected by any unauthorised person or persons, in which event the policy shall be rendered void.
4. Vehicles where the Insured or driver of the vehicle has had his/her driver's licence endorsed due to drunken or reckless driving.
5. Vehicles where vehicles are modified or altered from the manufacturer's specifications and such modifications or alterations influence the trade-in value of the vehicle.
6. Any “kit” cars.
7. Any rebuilt vehicles.

As will appear from a consideration of the above example, the policy provides that the insurer agrees to indemnify the insured person for the loss of value of a vehicle at the actual trade-in or re-sale of the insured vehicle due to the vehicle having been repaired as a result of accident damage, subject to the terms, exceptions and conditions contained in the policy, and subject to the maximum limit of 50 000 South African rands.

The basis of the settlement is the difference between the highest available quotation in the market and the trade-in value as evidenced in the most recent publication of an agreed independent third party at the time of actual trade-in or re-sale of the insured vehicle, subject to the additional considerations referred to in the policy.

A single premium is due within 15 days of-the date of the purchase by the insured person of the vehicle.

The insurance endures for the duration of any finance or lease agreement applicable to the vehicle, subject to a maximum period of 60 months if the vehicle is not the subject of a finance agreement.

The cover afforded by the policy is limited to vehicles driven within the Republic of South Africa, Namibia, Swaziland, Lesotho and Botswana.

The policy only covers an insured vehicle that is a new vehicle at the time when it is purchased by the insured person.

The insured person is obliged to ensure that the vehicle is serviced and properly maintained in accordance with the manufacturer's specifications and other stipulations in the policy.

In order to claim, the insured person must obtain and submit to the insurer three quotations from different franchise dealers for the values at which the dealers are prepared to purchase or exchange the vehicle.

By means of the invention the insured person may be compensated for a loss incurred as a result of the actual consideration obtainable by the insured person for the insured article, when the insured person disposes of it, being less than the consideration which the insured person would have received due to the insured article having been damaged in an accident, notwithstanding that the article was competently repaired after the accident.

1. An insurance product comprising a policy whereby the insurer undertakes to compensate an insured person for a loss incurred as a result of the actual consideration obtainable by the insured person for an insured article being less than an agreed minimum consideration, when the insured person disposes of the insured article.

2. An insurance product as claimed in claim 1, in which the insured article is a motor vehicle.

3. An insurance product as claimed in claim 1, in which the compensation is for a loss incurred as a result of a diminution in the value of the insured article due to the insured article having been damaged in an accident, notwithstanding that the insured article was competently repaired after the accident.

4. An insurance product as claimed in claim 3, in which the compensation is in respect of the whole of the loss.

5. An insurance product as claimed in claim 1 in which the minimum consideration is an average price for articles of the same kind as the insured article, as determined by an independent party.

6. A method of insuring an article which includes undertaking to compensate an insured person for a loss incurred as a result of the actual consideration obtainable by the insured person for the insured article being less than an agreed minimum consideration, when the insured disposes of the insured article.

7. A method of insuring an article as claimed in claim 6 in which the compensation is for a loss incurred as a result of a diminution in the value of the insured article due to the insured article having been damaged in an accident, notwithstanding that the insured article was competently repaired after the accident.

8. A method of insuring an article as claimed in claim 6 in which the minimum consideration is an average price for articles of the same kind as the insured article, as determined by an independent third party.

9. A method of compensating which includes compensating an insured person, when the insured person disposes of an insured article, for a loss incurred as a result of the actual consideration obtainable by the insured person for the insured article being less that an agreed minimum consideration.

10. A method of compensating an insured person as claimed in claim 9 in which the compensation is for a loss incurred as a result of a diminution in the value of the insured article due to the insured article having been damaged in an accident, notwithstanding that the insured article was competently repaired after the accident.

11. A method of compensating an insured person as claimed in claim 9 in which the minimum consideration is an average price for articles of the same kind as the insured article, as determined by an independent third party.
